(19) United States
(12) Patent Application Publication
(10) Pub. No.: US 2002/0074022 A1
(43) Pub. Date: Jun. 20, 2002

(54) Method and device for the cleaning of objects using a compressed cleaning fluid

(76) Inventor: Karsten Loehr, Ulm (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 09/993,427

(22) Filed: Nov. 6, 2001

(30) Foreign Application Priority Data
Nov. 7, 2000 (DE) 100 55 127.0

(51) Int. Cl. B08B 7/04

(52) U.S. Cl. 134/30; 134/111; 134/37

(57) ABSTRACT

A method for cleaning objects (4) in a pressure tank (2) using a compressed clean fluid, which contains a gas and which is compressed and decompressed one or more times. According to the present invention, the cleaning fluid is decompressed to a pressure at which the gas has a volume that is a multiple of the volume of the compressed cleaning fluid in the pressure tank. In this manner, it is possible to remove particle-sized and other impurities from recesses, blind holes, or open cavities (6) in the objects.

This application claims priority of German Application No. 10055127, filed Nov. 7, 2000, which is hereby incorporated by reference herein.

### BACKGROUND INFORMATION

The present invention relates to method and a device for the cleaning of objects in a pressure tank using a compressed cleaning fluid, which contains a gas and which is compressed and decompressed one or more times in succession.

U.S. Pat. No. 5,514,229 describes a method of this type for cleaning using a cleaning fluid, which is in a near- or supercritical state, i.e., in a state in which no distinction is possible between liquid and gas. Between a near- or supercritical state, on the one hand, and a supercritical state, on the other hand, periodic pressure changes occur, altering the solubility of the fluid for specific impurities. The impurities that are precipitated out in a decompression phase can be separated. This means that using this method only soluble impurities can be removed.

Insoluble impurities of machined parts, for example, manufacturing residues such as molding sand or shavings, processing residues such as coverings or bore dust, or accidental contamination such as dust, are conventionally removed in mechanical fashion, for example, through the intensive relative motion of a cleaning fluid and the objects to be cleaned, it being possible to add mechanical scouring agents to the cleaning fluid. However, cleaning methods of this type are less effective, the more complicated the shapes are of the objects to be cleaned. It is particularly difficult to remove impurities which are located in recesses, for example, blind holes or open cavities in the objects. In cleaning using a conventional cleaning fluid, it is necessary to assure a simultaneous supply and removal of the fluid; otherwise the result is a blockage without an exchange of the cleaning fluid. The more complex, the deeper, and the larger the recesses are, the more difficult this process becomes.

### SUMMARY OF THE INVENTION

The present invention provides a method for the cleaning of objects in a pressure tank using a compressed cleaning fluid, which contains a gas and which is compressed and decompressed one or more times, wherein the cleaning fluid is decompressed to a pressure at which the gas has a volume that is a multiple of the volume of the compressed cleaning fluid in the pressure tank (2; 20).

The present invention also provides a device for the cleaning of objects using a cleaning fluid, having a pressure tank for receiving the objects to be cleaned and having a compressor for the cleaning fluid. The device is characterized by a lifting piston device (22) having a lifting piston (24), which is coupled in a drive relationship to the compressor (14) and which subdivides the lifting piston device into two chambers (28, 30), a first chamber (28) of the lifting piston device being connected via a first valve (32) to a pressure reservoir (16), which is connected to the outlet of the compressor (14) and, via a second valve (18), to the pressure tank (20), and a second chamber (30) of the lifting piston device being connected via a third valve (38) to the pressure tank and being connected via a fourth valve (40) to a separator (42) for impurities.

According to the present invention, the cleaning fluid is decompressed to the point that, in the event that the cleaning fluid is a gas, the latter expands to a multiple of the volume of the compressed gas, preferably to a volume in the order of magnitude of 100 times the volume of the compressed gas. Alternatively, the cleaning fluid can be a liquid, in which the gas is soluble in the compressed state. In this case, the decompression is carried out so that here too a multiple of the volume of the compressed cleaning fluid is released as gas.

If the gas expands or is released, there arise in recesses in the objects to be cleaned currents directed outwards which effectively carry with them the impurities. If the compression and decompression are carried out repeatedly, the impurities again and again being precipitated out from the cleaning fluid, then components having complex shapes can be cleaned very carefully.

In one refinement of the method, a non-gaseous material, in which the compressed cleaning fluid is soluble and which has the tendency to bind itself to impurities, is applied to an object to be cleaned and/or is introduced into any open cavities in the object, before the object is placed into the pressure tank. The nongaseous material, which is advantageously liquid, plastic, or pasty, in order to assure an effective binding to the impurities, forms so-called removal aids. As a result of the solubility in the compressed cleaning fluid, the removal aids in response to decompression are removed from the recesses particularly effectively and, in the process, take the impurities with them. In this manner, it is possible to reliably remove very heavy, very small, or very inaccessible impurities. If the cleaning fluid is composed of carbon dioxide, suitable removal aids are commercial alcohols, oils, fats, or waxes on a hydrocarbon base, in which carbon dioxide is soluble.

Both in the basic form of the method as well as in the refinement using removal aids, the cleaning fluid in the compression phase of the cleaning process can attain a supercritical state. But during the entire cleaning phase, the fluid can also remain in a subcritical state, because the change in the gas volume as a function of pressure is in any case greatest in the subcritical range, as is desirable for generating intensive, effective expansion currents from the recesses.

If removal aids are used, it is still possible that residues from them remain adhering to the objects. Removal-aid residues of this type are preferably removed by compressing the cleaning fluid at the end of the method, for example, to a near- or supercritical state. In this state, the appropriate removal aids are particularly soluble in the cleaning fluid and are flushed away along with it.

In another refinement of the method, the pressure tank, before the cleaning process, is essentially completely filled by one or a multiplicity of objects to be cleaned as well as by a multiplicity of solid filling bodies. In this case, the pressure tank must be filled with significantly less cleaning fluid, so that compression work is saved.

A further saving on compression work is made possible by the device according to the present invention, which contains a lifting piston, which is coupled in a drive relationship to a compressor for the cleaning fluid, so that the work that is released in the decompression is partially recovered for the compression work of the compressor.

### BRIEF DESCRIPTION OF THE DRAWINGS

Further features and advantages of the present invention are yielded from the following description of exemplary embodiments on the basis of the drawing. The following are the contents:

FIGS. 1a and 1b depict block diagrams for illustrating the method for cleaning complex machined parts,

FIGS. 2a and 2b depict block diagrams for illustrating one variant of the method for cleaning complex machined parts, and

FIGS. 3a and 3b depict block diagrams for illustrating a device for cleaning complex machined parts.

### DETAILED DESCRIPTION

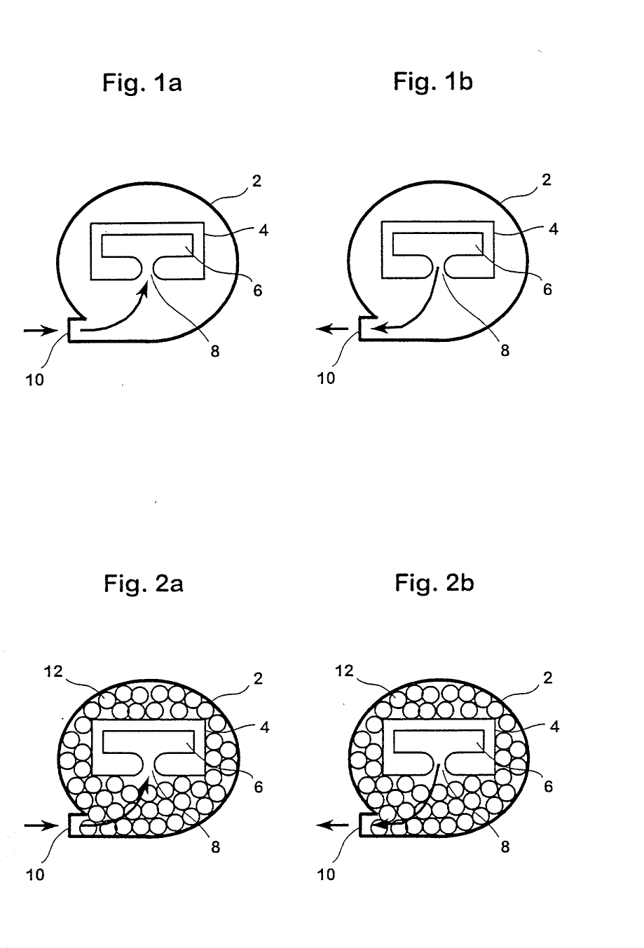

FIGS. 1a and 1b both depict a closed pressure tank 2, in which a complex machined part 4 is situated. Machined part 4 contains a cavity 6, which is connected to the outside by a narrow opening 8. Machined part 4 is any product which is soiled, for example, by manufacturing residues such as molding sand, shavings or cooling lubricants, processing residues such as coverings or bore dust, or accidental contamination such as dust. Machined part 4 as sketched can be, for example, a casting, which is soiled by residues of molding sand which are located especially in cavity 6. Machined part 4, however, can also be any other product which contains any areas that are hard to access, for example, recesses, undercuts, holes, blind holes, or channels, which in each case constitute a cavity 6.

To remove the impurities from machined part 4, pressure tank 2 is opened, machined part 4 is placed in it, and pressure tank 2 is securely closed. Via an inlet 10, a highly compressed gas such as carbon dioxide is introduced, or is generated by pumps (FIG. 1a). As soon as a desired pressure is achieved, decompression via inlet 10 occurs spontaneously (FIG. 2). In this context, the volume of the gas increases, and the gas exits from opening 8. This gas flow takes particles and other impurities in cavity 6 with it. In order that the gas flow be sufficiently intensive, the decompression should occur as rapidly as possible. This means that the pressure equalization between the interior of pressure tank 2 and, for example, the atmosphere should take place essentially more rapidly than the pressure equalization between cavity 6 and the interior of pressure tank 2.

The pressures to which the gas is alternately compressed and decompressed are selected so that, in decompression, the volume of the gas increases by a multiple, for example, by 200 times. At a volume increase of this magnitude, the expansion current from cavity 6 is intensive enough for a powerful cleaning effect. To remove impurities to the greatest extent possible, the compression and decompression are carried out repeatedly, the gas again and again being filtered so that no impurities are recycled into cavity 6.

Volume changes in the above-mentioned order of magnitude require a significant amount of compression work, which constitutes a large part of the operating costs. The energy level of pressure tank 2 is the product of pressure and residual volume (the volume of pressure tank 2 minus the volume of machined part 4). To reduce the residual volume, in addition to machined part 4 and any further objects to be cleaned, it is possible to fill pressure tank 2 with a multiplicity of compact filling bodies 12, as is depicted in FIGS. 2a and 2b. Filling bodies 12 are, for example, solid spheres made of a material that stands up to the compression pressure without changing in volume. Minimizing the residual volume results in proportionate savings in the compression work to be exerted.

In a further exemplary embodiment, machined part 4 is first provided with removal aids, before the method is carried out as described above. The removal aids are substances that at the working temperature are liquid, plastic, or pasty, and in which the gas is soluble. In the event that the gas is carbon dioxide, the appropriate removal aids are commercial alcohols, oils, fats, or waxes made on a hydrocarbon base. Machined part 4 to be cleaned is covered or filled with removal aids, the removal aids surrounding the impurities and binding to them physically or chemically. In the compression phase, the gas dissolves in the removal aids, and in response to the spontaneous expansion, the gas that is released takes the removal aids and therefore the impurities bound to them with it. The removal aids are driven out together with the impurities. In practice, however, it is possible that residues of the removal aids can remain adhering to the component. In this case, the component must be cleaned using a subsequent supercritical extraction of the remaining removal-aid residues. For example, a wax as the removal aid is very soluble in carbon dioxide which is in a supercritical state.

Furthermore, in certain types of impurities, it is possible to use the impurities themselves as removal aids. If carbon dioxide is used as the cleaning fluid, then impurities themselves act as removal aids, for example, in the form of cooling lubricants or coverings on a hydrocarbon base.

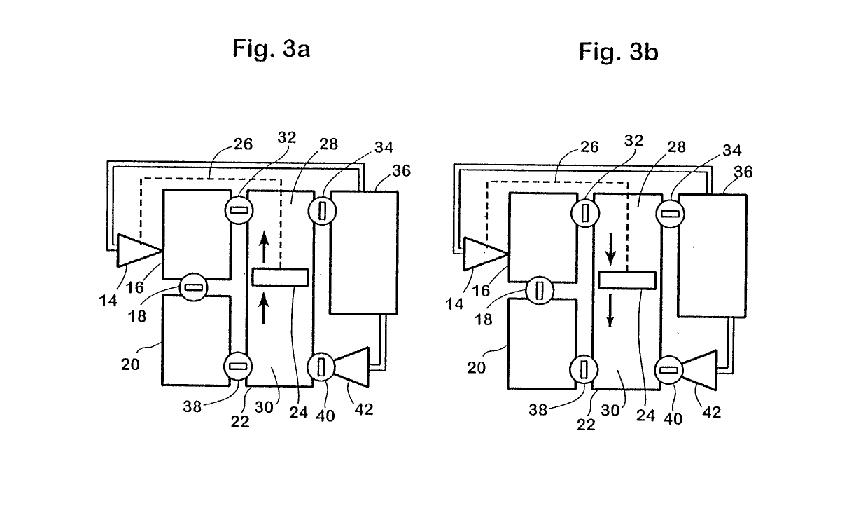

FIGS. 3a and 3b are block diagrams for illustrating the exemplary embodiments for a device for carrying out the method described above. The device contains a compressor 14, whose outlet is connected to a pressure reservoir 16. Pressure reservoir 16 is connected via a valve 18 to a pressure tank 20 as a receptacle for the objects to be cleaned. In addition, the device contains a lifting piston device 22, which is a hollow cylinder that is closed on both ends so as to be gas-tight and in which an axially movable piston 24 is located. Piston 24 is coupled in a drive relationship to compressor 14, for example, by a joint piston rod or by a connecting rod and a crank, as is indicated by a dotted line 26. In the event compressor 14 is a lifting piston compressor, the piston of compressor 14 and the piston of lifting piston device 22 can also be arranged in a common hollow cylinder and can be coupled to each other via a piston rod, which extends in a gas-tight manner through a separating wall between compressor 14 and lifting piston device 22.

Piston 24 divides lifting piston device 22 into a first chamber 28 and a second chamber 30. First chamber 28 is connected via a valve 32 to a pressure reservoir 16 and via a valve 34 to a reserve tank 36 for the cleaning fluid. Second chamber 30 is connected via a valve 38 to pressure tank 20 and via a valve 40 to a separator 42 for impurities, whose outlet is connected to reserve tank 36. Reserve tank 36 is also connected to the inlet of compressor 14.

FIG. 3a depicts the decompression phase in which valves 32 and 38 are opened and valves 18, 34, and 40 are closed. Piston 24 moves upwards in the direction indicated by the arrow, to decompress pressure tank 20 and in the process to clean the objects contained therein. The gas emerging from pressure tank 20 partially directly supports the expulsion of the gas from first chamber 28 into pressure reservoir 16, and it partially supports, via coupling 26, compressor 14, which also fills pressure reservoir 16 with gas.

FIG. 3b depicts the compression phase, in which valves 32 and 38 are closed and valves 18, 34, and 40 are opened. While pressure tank 20 is filled via valve 18 with compressed air from pressure reservoir 16, piston 24 moves downwards in the direction indicated by the arrow, to drive the gas, which has accumulated during the decompression phase in second chamber 30, through separator 42 and reserve tank 36 into compressor 14 and first chamber 28. Reserve tank 36 acts here as a buffer for the gas that has been purified in separator 42. However, the gas can also be conveyed from separator 42 directly into compressor 14 and first chamber 28. Reserve tank 36 is then required only for supplying fresh gas at the beginning of the method or for adjusting for leakage losses.

Expelling gas in second chamber 30 and drawing in gas in first chamber 28 during the compression phase can be supported or carried out by storing the work achieved during the decompression phase in piston 24, e.g., in a driven plate such as a disk flywheel, which is connected to piston 24 via a crank and a connecting rod, and which in lifting piston device 22 is used for the expelling and the drawing-in processes.

“A multiple of” as defined herein means many times over, i.e. at least twice, and need not be an exact integer.

What is claimed is:

1. A method for the cleaning of objects in a pressure tank using a compressible cleaning fluid including a gas, the method comprising the steps of:
compressing and decompressing the cleaning fluid at least one time,
the cleaning fluid being decompressed in the decompressing step to a pressure at which the gas has a volume that is a multiple of the volume of the compressed cleaning fluid in the pressure tank.

2. The method as recited in claim 1, wherein the cleaning fluid essentially comprises the gas.

3. The method as recited in claim 1, wherein a nongaseous material is at least one of (a) applied to an object that is to be cleaned; and (b) introduced into any open cavities in the object before the object is placed into the pressure tank, the compressible cleaning fluid being soluble in the nongaseous material and having the tendency to bond to impurities.

4. The method as recited in claim 3, wherein the nongaseous material is liquid, plastic, or pasty.

5. The method as recited in claim 4, wherein the cleaning fluid is composed of carbon dioxide and the nongaseous material contains at least one of alcohol, oil, fat, and wax on a hydrocarbon base.

6. The method as recited in claim 3, wherein the cleaning fluid, after the objects are cleaned of impurities, is compressed to a near- or supercritical state, in which the nongaseous material is soluble in the cleaning fluid, to remove any residues of the nongaseous material from the objects.

7. The method as recited in claim 1 wherein the pressure tank, before the cleaning, is filled by one or more objects to be cleaned as well as by a plurality of solid filling bodies.

8. A device for the cleaning of objects using a cleaning fluid comprising:
a pressure tank for receiving the objects to be cleaned;
a compressor for the cleaning fluid having an outlet,
a lifting piston device having a lifting piston coupled in a drive relationship to the compressor, the lifting piston subdividing the lifting piston device into a first and a second chamber, the first chamber being connected via a first valve to a pressure reservoir connected to the outlet of the compressor and being connected via a second valve to the pressure tank, and the second chamber being connected via a third valve to the pressure tank and being connected via a fourth valve to a separator for impurities.
